(19) United States
(12) Patent Application Publication
(10) Pub. No.: US 2018/0148297 A1
(43) Pub. Date: May 31, 2018

(54) CAR OPERATION PANEL OF AN ELEVATOR SYSTEM

(71) Applicants: Dirk H. TEGTMEIER, Berlin (DE); Otis Elevator Company, Farmington, CT (US)

(72) Inventors: Dirk H. Tegtmeier, Berlin (DE); Peter Herkel, Berlin (DE)

(21) Appl. No.: 15/570,463

(22) PCT Filed: Apr. 30, 2015
(86) PCT No.: PCT/EP2015/059568

§ 371 Date: Oct. 30, 2017

(51) Int. Cl. B66B 1/46; B66B 5/00

(52) U.S. Cl. CPC B66B 1/466; B66B 5/0087

(57) ABSTRACT

Embodiments as disclosed herein provide a car operation panel for commanding travel of an elevator car from a boarding landing to a destination landing during normal operation of an elevator system. The car operation panel has a plurality of car operation switches to be operated by a passenger from inside of the elevator car during normal operation of the elevator system. The car operation panel is mechanically convertible such as to switch the car operation panel from a first configuration corresponding to the normal operation mode to a second configuration corresponding to an inspection and maintenance operation mode. The car operation panel, when switched to the second configuration, allows manual control of the elevator car to travel in up direction and/or in down direction by operating at least a part of the car operation switches of the car operation panel.

The present invention relates to a car operation panel of an elevator system and to an elevator car having such car operation panel.

Car operation panels are provided in elevator cars in order to allow passengers to enter a destination landing or floor from inside the car.

Besides operating in such normal operation modes in which an elevator car travels between landings in response to a service request by a passenger, elevator systems may be operated from time to time in specific inspection and maintenance operation modes. While in normal operation modes, travel of the car is controlled largely automatically according to predetermined travel profiles, operation of the car in inspection and maintenance operation modes often requires to control movement of the elevator car manually by a service person. Usually, such manual control of car movement is activated and controlled by a service person operating a specific inspection and maintenance operation control terminal. In most elevator installations, the inspection and maintenance operation control terminal is located close to the drive machine, but still in a position easily accessible for the service person. For elevators having the drive machine located in a separate machine room the inspection and maintenance operation control terminal is often located in the machine room. For machine room-less elevators where the drive machine is positioned in the hoistway, often in the top of the hoistway, the inspection and maintenance operation control terminal may be located at one of the floors such as to be accessible from the hall outside the hoistway. Alternatively, or in addition, an inspection and maintenance operation control terminal provided on the top of the elevator car has proven to be useful. Using a top of the car operation control terminal allows a service person to manually move the car in upward or downward direction for inspection and maintenance purposes while standing on the top of the car.

According to U.S. Pat. No. 6,405,834 B1 a maintenance driving control terminal is provided by a hall call terminal located at one of the halls of an elevator system. The respective hall call terminal has a front face including hall call buttons to be operated in normal operation modes for entering hall calls. The front face of the hall call terminal may be opened by a service person and pivoted away such that a maintenance driving control terminal becomes accessible to the service person. The maintenance driving control panel may be taken out by the service person thereby allowing the service person to manually operate the car by actuating RUN/STOP switches and UP/DOWN switches provided on the maintenance driving control panel.

U.S. Pat. No. 7,281,609 B2 and EP 2 336 071 A1 disclose elevator systems having an inspection and maintenance operation control box provided on top of the car such that manual operation of the car can be controlled by a service person standing on top of the car during inspection and maintenance work.

U.S. Pat. No. 5,817,994 discloses a remote control arrangement for generating manual car operation commands remotely, in order to facilitate inspection service in an elevator system. The remote control arrangement includes a remote car command wireless transmitter (e.g. handheld) similar to a garage door opener, and a wireless receiver suitably connected in the car operation panel of an elevator car. The receiver is detachably connected to wiring which leads to the elevator controller. After finishing the use of the transmitter/receiver arrangement, elevator service personnel detaches the receiver from the elevator wiring leading to the controller, in order to avoid abuse of the receiver in normal operation.

U.S. Pat. No. 7,798,291 B2 discloses an emergency operation device for operating an elevator car in case of an emergency by authorized persons, like the fire department, as required in certain countries like the USA (so-called fire fighter function). The emergency operation device is suitable for installation in an elevator car and comprises an emergency control region which is to be opened in a top part of a car operation panel through insertion of an emergency key into an emergency key slot provided in the car operation panel and turning the emergency key. The emergency control region is normally closed by a cover which is unlocked and freed by the turning of the emergency key, such that specific emergency operation switches become accessible after the cover has been pivoted away.

It would be desirable to provide a more convenient possibility for entering an inspection and maintenance operation mode and allowing to manually control movement of an elevator car for inspection and maintenance purposes. However, any more convenient possibility should not invoke a larger risk of abuse of such manual control of car movement by unauthorized persons.

The embodiments disclosed herein allow an authorized service person to manually control movement of an elevator car from inside the car.

Embodiments as disclosed herein provide a car operation panel for commanding travel of an elevator car from a boarding landing to a destination landing during car operation of an elevator system. The car operation panel has a plurality of normal operation switches to be operated by a passenger from inside the car during normal operation of the elevator system. The car operation panel is mechanically convertible such as to switch the car operation panel from a first configuration corresponding to the normal operation mode to a second configuration corresponding to an inspection and maintenance operation mode. The car operation panel, when switched to the second configuration, allows manual control of the elevator car to travel in upward direction and/or in downward direction by operating at least a part of the car operation switches of the car operation panel.

Further embodiments relate to an elevator car including such car operation panel.

Further embodiments relate to an elevator system including such elevator car.

Further exemplary embodiments will be described in more detail in the following by taking reference to the enclosed Figures.

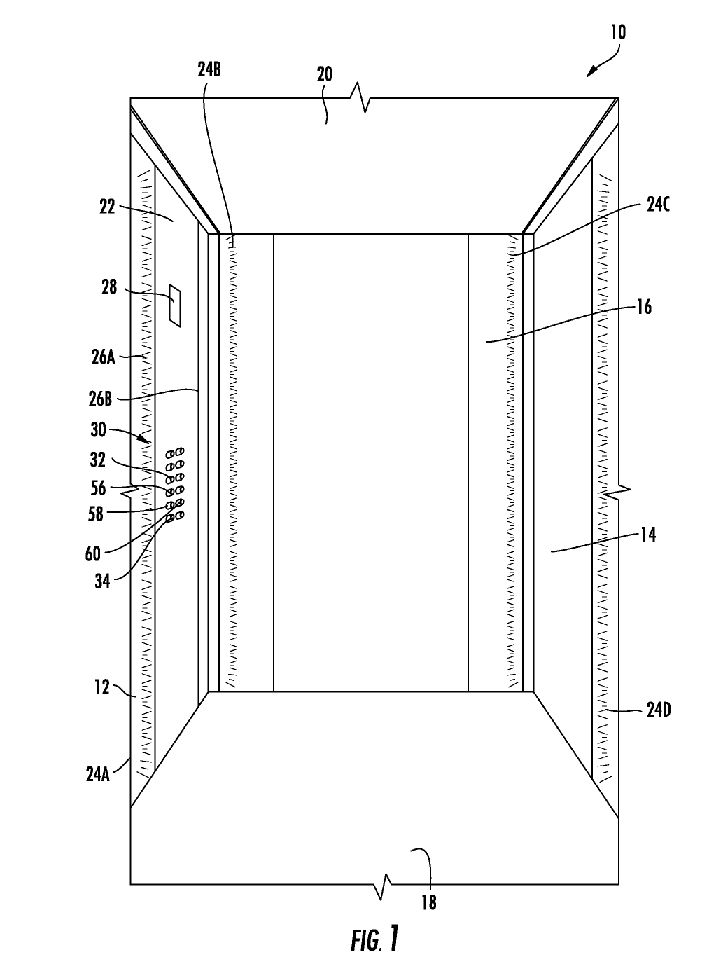

FIG. 1 shows an elevator car according to an embodiment.

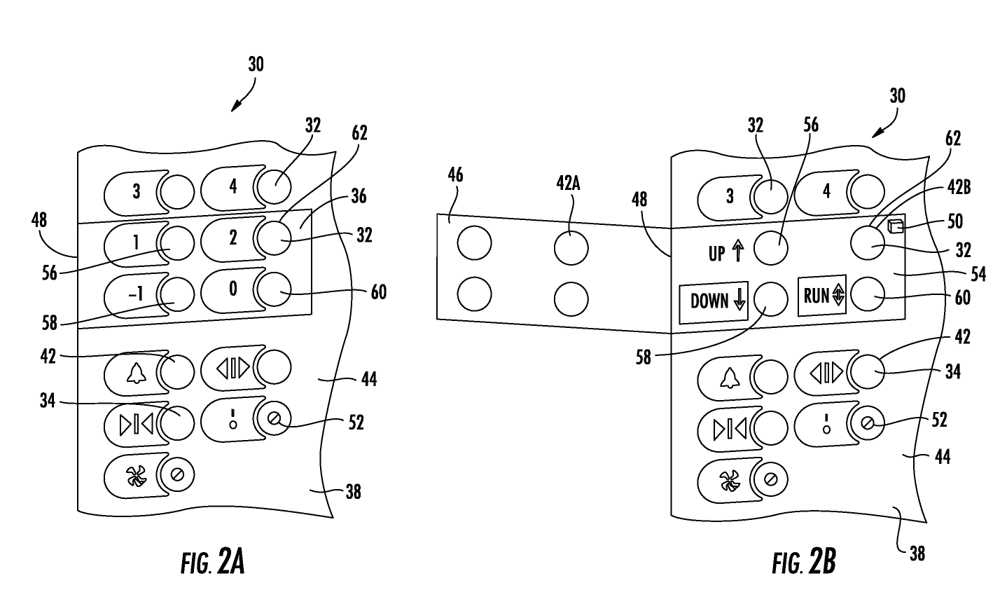

FIGS. 2A and 2B show a portion of a car operation panel according to a first embodiment in a configuration corresponding to normal operation mode (FIG. 2A) and in a configuration corresponding to inspection and maintenance operation mode (FIG. 2B).

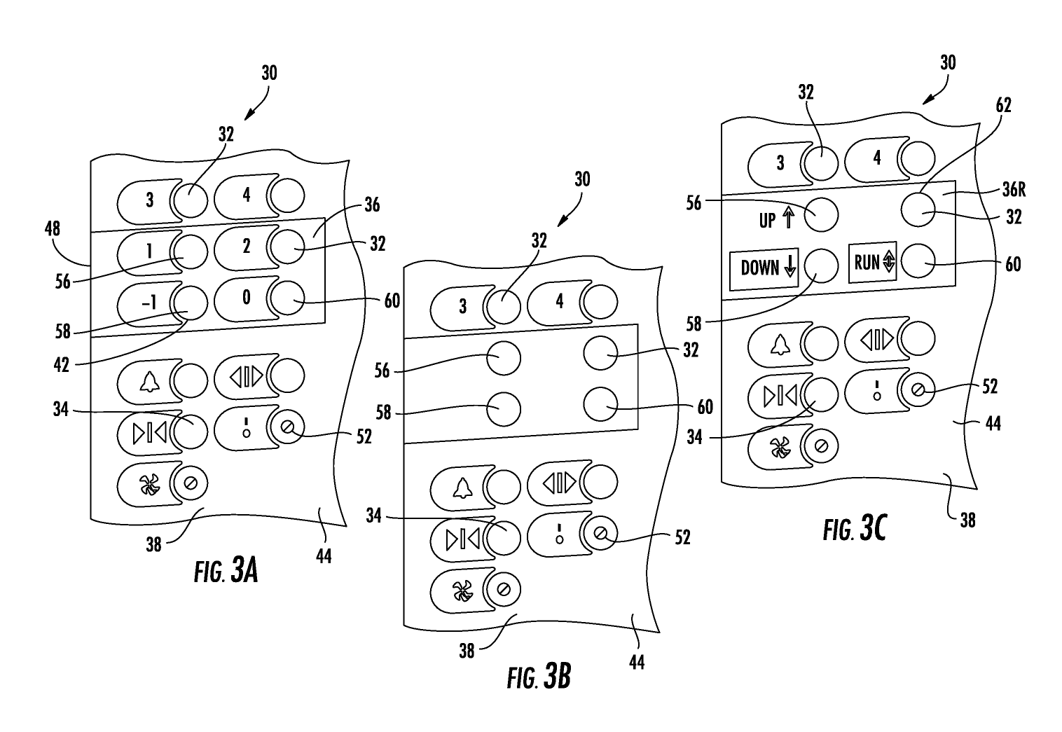

FIGS. 3A, 3B, and 3C show a portion of a car operation panel 30 according to a second embodiment in a configuration corresponding to normal operation mode (FIG. 3A), in a configuration corresponding to an intermediate stage after detachment of a portion of the cover of car operation panel (FIG. 3B), and in a configuration corresponding to inspection and maintenance operation mode (FIG. 3C).

FIG. 1 shows an elevator car 10 according to an embodiment. The elevator car 10 is shown in a view through the open front doors (not shown in FIG. 1) into the interior of the elevator car 10. Visible in FIG. 1 is a left interior side wall 12, a right interior side wall 14, a back interior side wall 16, a floor or landing 18, and a ceiling 20 of the elevator car 10. The left interior side wall 12 is provided with a central column 22 extending from the floor 18 to the ceiling 20. Column 22 projects from left interior side wall 12. Vertically extending illumination profiles 24A, 24B, 24C, and 24D are provided in each of the four corners of the interior of elevator car 10. Additional vertically extending illumination profiles 26A and 26B are provided on the sides of column 22.

Column 22 is provided with a display 28 and with a car operation panel 30. Car operation panel 30 comprises a number of car operation switches 32, 34, 56, 58, 60. Car operation switches 32, 34, 56, 58, 60 each have the configuration of a push button. In normal operation of the elevator car 10, car operation switches 32, 56, 58, 60 are operated by passengers to input so-called car calls, i.e. a passenger having entered the car inputs her or his desired destination floor by pressing one of the car operation switches 32, 56, 58, 60 being assigned to the passenger's desired destination landing. Car operation switches 32, 56, 58, 60 are also referred to as car call switches or car call buttons. For each of the destination floors or destination landings serviced by elevator car 10, car operation panel 30 includes a respective car operation switch 32, 56, 58, 60 being designated by the number of that floor or destination landing, or by some other designation of that floor or destination landing (e.g. the floor with the main entrance might be designated by “0” and/or “Lobby”, a floor where a restaurant is located might be designated by the number of that floor and/or by “Restaurant”, a top floor might be designated by “Observation Floor”, etc.). Pressing the car operation switch 32, 56, 58, 60 corresponding to a desired destination landing will enter a car call with respect to that destination landing to the elevator controller, and in response to the car call being entered the elevator controller will dispatch the elevator car 10 to travel towards that destination landing and stop at that destination landing, following a predefined dispatching algorithm. The car operation panel 10 also includes additional car operation switches 34 which are not assigned to destination landings, but are used to command additional functions as commonly provided for normal operation of an elevator. E.g. the additional car operation switches 34 might include a car door open switch and a car door close switch for allowing passengers to command the car doors to open or close. Additional car operation switches 34 usually will also include at least one alarm switch allowing passengers to call for assistance in case of an emergency.

Configuration and operation of the car operation panel 30 will be described in more detail with respect to the embodiments shown in FIGS. 2A/2B and in FIGS. 3A to 3C, respectively. The configuration described with respect FIG. 1 applies to both embodiments according to FIG. 2A/2B and FIG. 3A to 3C, unless specified otherwise.

FIGS. 2A and 2B show a portion of a car operation panel 30 according to a first embodiment. FIG. 2A shows the car operation panel in a configuration according to normal operation mode in which passengers can enter car calls by pressing respective ones of the destination call switches 32, 56, 58, 60, as described above. FIG. 2B shows the car operation panel 30 in a configuration according to an inspection and maintenance operation mode, i.e. when the car operation panel 30 has been switched into the inspection and maintenance operation mode as it will be described in more detail hereinafter.

The car operation panel 30 shown in FIGS. 2A and 2B includes a detachable portion 36. Detachable portion 36 forms part of an essentially flat front cover 38 of the car operation panel 30. In the normal operation mode, the detachable portion 36 and the remaining non-detachable part 44 of front cover 38 are flush to each other such as to form an essentially flat front face of the car operation panel 30. Front cover 38 is provided with a plurality of openings or receptacles 42 in which respective car operation switches 32, 34, 56, 58, 60 are accommodated. The same type of openings or receptacles are provided in the detachable portion 36 and in the remaining non-detachable part 44 of front cover 38. Car operation switches 32, 34, 56, 58, 60 are supported by car operation panel 30 independently of front cover 38, such as to be operable by a passenger with respect to the front cover 38. In the normal operation mode, car operation switches 32, 34, 56, 58, 60 are also essentially flush with front cover 38, or do project from front cover 38 slightly. Operation of the car operation switches 32, 34, 56, 58, 60 will usually involve actuating the car operation switches mechanically, e.g. by pressing car operation switches towards its respective receptacle. To allow such mechanical actuation, car operation switches 32, 34, 56, 58, 60 are supported movably with respect to front cover 38 which remains stationary. However, other mechanisms for operating car operation switches 32, 34, 56, 58, 60 are conceivable as well, e.g. operation by way of heat transfer when the car operation switches 32, 34, 56, 58, 60 are touched by a passenger, operation by change in capacity when the car operation switches 32, 34, 56, 58, 60 are touched or pressed by a passenger, or change in resistivity when the car operation switches 32, 34, 56, 58, 60 are touched or pressed by a passenger. In the normal operation mode shown in FIG. 2A, the detachable portion 36 of front cover 38 and the remaining non-detachable part 44 of the front cover 38 together form an essentially flush front face such that presence of detachable portion 36 is not necessarily visible.

As visible in FIG. 2B, in the embodiment of FIGS. 2A and 2B, detachable portion 36 has the configuration of a flap 46 being pivotably supported with respect to front cover 38 by a hinge 48. In the normal operation mode of car operation panel 30, the detachable portion 36 is secured in its closed position as shown in FIG. 2A by a lock 50 (not visible in FIG. 2A, but shown in FIG. 2B). Lock 50 is not accessible from the front face of front cover 38 such that an abusive opening of detachable portion 36 is excluded.

In order to bring the car operation panel 30 into the configuration of FIG. 2B corresponding to the inspection and maintenance operation mode, it is required to insert a key into a specific keyhole 52 provided on the car operation panel 30 as well (see right bottom side in FIGS. 2A and 2B) and turn that key from a locking position (shown in FIG. 2A) into a release position (shown in FIG. 2B). Only when the key is inserted into keyhole 52 and turned to the release position, will lock 50 be brought into an inactive configuration in which it does not prevent to open detachable portion 36 and pivot detachable portion 36 into the open position shown in FIG. 2B.

As inferable from FIG. 2B, in the open position of the detachable portion 36, an auxiliary front cover 54 becomes visible. The auxiliary front cover 54 is superposed by detachable portion 36 in the normal operation mode, and therefore is not visible in FIG. 2A. The detachable portion 36 is locked to the auxiliary front cover 54 until the key inserted into keyhole 52 is turned into the release position shown in FIG. 2B. However, detachable portion 36 does not immediately open when detachable portion 36 becomes unlocked with respect to auxiliary front cover 54. Rather, in order to activate the inspection and maintenance operation mode, it is necessary to actively pull detachable portion out of the recess in which it is accommodated and pivot detachable portion into the open configuration shown in FIG. 2B. Only when the detachable portion has been pivoted away from the front cover 38 about a predefined angle (in FIG. 2B, the detachable portion has been pivoted at about 180 degrees with respect to the front cover 38), will the inspection and maintenance operation mode be activated. This ensures that the inspection and maintenance mode neither can be activated by unauthorized persons (because it is required to insert a suitable key into keyhole 52), nor can be activated inadvertently (since it is required to insert and turn the activation key, as well as to pivot the detachable portion to a predefined angle).

FIG. 2B shows that three of the car operation switches 32, 56, 58, 60 assigned to specific destination landings in the normal operation mode (namely assigned to destination landings −1, 0, and 1 respectively) are assigned to new functions in the inspection and maintenance operation mode: car operation switch 56 is now assigned to the function of commanding the car to manually travel in the up direction (=UP command), car operation switch 58 is now assigned to the function of commanding the car to manually travel in the down direction (=DOWN command), and car operation switch 60 is now assigned to the function of a car travel release switch releasing movement of the car in up/down direction (=RUN command). Simultaneous operation of the UP command switch 56 and the car travel release switch 60 will cause the car to travel manually in upward direction in the inspection and maintenance mode. Simultaneous operation of the DOWN command switch 58 and the car travel release switch 60 will cause the car to travel manually in downward direction in the inspection and maintenance mode.

Any other car operation switches 32 assigned to specific destination landings in the normal operation configuration do not have any function anymore in the inspection and maintenance operation mode. Operating these switches 32 will have no effect in the inspection and maintenance operation mode.

Since the detachable portion 36 is pivoted away from front cover 38 in the configuration of FIG. 2B corresponding to the inspection and maintenance operation mode, the car operation switches 56, 58, and 60 to be operated for manually moving the car project slightly from the auxiliary front cover 54. Such configuration bears the risk of an inadvertent actuation of the car operation switches 56, 58, 60. Such risk is mitigated by the fact that for allowing a movement of the car at least two of these switches have to be operated simultaneously, and that the switches 56 and 60, as well as the switches 58 and 60 have a distance from each other which is large enough to ensure that it will not be possible to operate both switches by using one hand only. In the embodiment of FIGS. 2A and 2B, as a further measure against inadvertent operation of any of the switches 56, 58, and 60 in the inspection and maintenance operation mode, auxiliary front cover 54 is provided with projecting collars 62 around each of the switches 56, 58, and 60. Openings 42A provided in the detachable portion 36 for accommodating the car operation switches 32, 56, 58, 60 have a slightly larger diameter than the diameter of the car operation switches 32, 56, 58, 60. Therefore, projecting collars 62 may project from auxiliary front cover 54 towards the front face such as to be flush with the detachable portion 36 in its retracted condition (as shown in FIG. 2A). When the detachable portion 36 is brought into its open state, the projecting collars 62 provide a protection against inadvertent operation of the car operation switches 56, 58, and 60. As visible in FIG. 2B, in addition to covering the car operating switches 56, 58, 60 used for manually operating the elevator car in the inspection and maintenance mode, the detachable portion 36 also covers one car operating switch 32 being inoperative in the inspection and maintenance mode.

A further embodiment of a car operation panel 30 is shown in FIGS. 3A to 3C and will be described in the following. In FIG. 3A to 3B the same reference signs are used as in FIGS. 2A and 2B in order to designate the same or corresponding components. To avoid replication, only differences of the embodiment according to FIGS. 3A to 3C with respect to the embodiment according to FIG. 2A/2B will be described, it is to be understood that otherwise the description set out above with respect to FIGS. 2A and 2B applies to the embodiment according to FIGS. 3A to 3C as well.

FIGS. 3A, 3B, and 3C show a portion of a car operation panel 30 according to a second embodiment. FIG. 3A shows the car operation panel 30 in a configuration corresponding to the normal operation mode. FIG. 3B shows the car operation panel 30 in a configuration corresponding to an intermediate stage after detaching a detachable portion 36 from the front cover 38 of car operation panel 30. FIG. 3C shows the car operation panel 30 in a configuration corresponding to a final stage, i.e in a configuration corresponding to the inspection and maintenance operation mode. Different from the embodiment shown in FIGS. 2A/2B, in the embodiment according to FIGS. 3A to 3C the detachable portion 36 of the front cover 38 is fully detachable from the front cover 38. In order to detach the detachable portion 36, a key must be inserted into keyhole 52 provided on the front cover and turned to a release position. With the key in the release position, the detachable portion 36 can be taken out of a receptacle formed in the front cover 38 such that an auxiliary front cover 54 becomes visible. This state is shown in FIG. 3B. However, the car operation panel 30 does not yet have been switched into the inspection and maintenance operation mode in the state shown in FIG. 3B. Rather, the detached portion 36 has to be re-attached to the car operation panel 30. More precisely, the detached portion 36 has to be turned such that its former back side 36R is now exposed to the front face and inserted again into the same receptacle in which the detachable portion was mounted in the configuration corresponding to normal operation. Only after the detachable portion has been re-attached to the car operation panel 30 in the backside-to-front orientation described before (and shown in FIG. 3C), the car operation switches 32, 56, 58, 60 assigned to destination landings −1, 0, and 1 respectively, in the normal operation mode (see FIG. 3A) are assigned to new functions in the inspection and maintenance operation mode: car operation switch 56 is now assigned to the function of commanding the car to manually travel in the up direction (=UP command), car operation switch 58 is now assigned to the function of commanding the car to manually travel in the down direction (=DOWN command), and car operation switch 60 is now assigned to the function of a car travel release switch releasing movement of the car in up/down direction (=RUN command). Simultaneous operation of the UP command switch 56 and the car travel release switch 60 will cause the car to travel manually in upward direction in the inspection and maintenance mode. Simultaneous operation of the DOWN command switch 58 and the car travel release switch 60 will cause the car to travel manually in downward direction in the inspection and maintenance mode. For example, the car operation panel 30 may comprise a sensor configured to detect that the mechanically detachable portion 36 has been detached and/or configured to detect that the mechanically detachable portion 36 has been re-attached in the correct position and/or in the correct orientation.

Any other car operation switches 32 assigned to specific destination landings in the normal operation configuration do not have any function anymore in the inspection and maintenance operation mode. Operating these switches 32 will have no effect in the inspection and maintenance operation mode.

As the detachable portion 36 is to be re-attached to the car operation panel 30, the manual car operation switches 56, 58, and 60 do not project from the front face of the car operation panel 30 in the configuration corresponding to the inspection and maintenance operation mode. As a further measure to prevent inadvertent operation of these manual car operation switches, the detachable portion 36 may be provided with collars 62 projecting from its back surface 36R. These collars 62 will be accommodated in corresponding receptacles when the detachable portion 36 is in the configuration corresponding to the normal operation mode (see FIG. 3A), however they will project from the front face of the car operation panel 30 in the configuration corresponding to the inspection and maintenance operation mode, and thus provide an additional protection against inadvertent operation of the manual car operation switches 56, 58, 60.

The embodiments described herein allow an authorized service person to manually control movement of an elevator car from inside of the car.

According to embodiments described herein, a car operation panel is provided for commanding travel of an elevator car from a boarding landing to a destination landing during normal operation of an elevator system. The car operation panel has a plurality of car operation switches to be operated by a passenger from inside of the car during normal operation of the elevator system. The car operation panel is mechanically convertible such as to switch the car operation panel from a first configuration corresponding to the normal operation mode to a second configuration corresponding to an inspection and maintenance operation mode. The car operation panel, when switched to the second configuration, allows manual control of the elevator car to travel in upward direction and/or in downward direction by operating at least a part of the car operation switches of the car operation panel.

Switching from the normal operation mode to the inspection and maintenance operation mode requires a mechanical change in the configuration of the car operation panel, other than a mere operation of one, or a plurality of, the car operation switches provided on the car operation panel. A mechanical change in the configuration of the car operation panel will be realized in case at least one component of the car operation panel is at least temporarily removed from the car operation panel. The component may be any part of the car operation panel including any of its car operation switches. Further, a mechanical change in the configuration of the car operation panel may be realized by removing a component from the car operation panel and reattaching that component at a different position and/or in a different orientation to the car operation panel. However, it should not be possible to switch the configuration of the car operation panel between normal operation mode and inspection and maintenance operation mode merely by means of software or by means of providing an electrical command to the car operation panel.

Neither should it be sufficient for switching the configuration of the car operation panel between the normal operation mode and the inspection and maintenance operation mode by merely operating one, or a combination, of the car operation switches provided on the car operation panel. Inserting a key into a keyhole provided on the car operation panel, and/or actuating the key in the keyhole (e.g. turning the key in the keyhole to a predefined position) may be conceivable as a precondition for allowing to change the configuration of the car operation panel between configurations corresponding to normal operation mode and configurations corresponding to inspection and maintenance operation mode. In such cases, inserting or actuating of the key will release a further mechanical change in the configuration of the car operation panel (e.g. a pivoting movement of a flap attached to the car operation panel, or a detaching and re-attaching of a portion of the front cover, as described below).

The mechanical conversion of the car operation panel may involve a modification with respect to at least part of the car operation switches. However, it will be beneficial if the position and configuration of at least those car operation switches to be used in the inspection and maintenance operation mode should remain unaffected by the mechanical conversion of the car operation panel has been completed, such that these switches can be used in the inspection and maintenance operation mode for manually operating the car.

The same car operation switches on the car operation panel are used for operating the car both in the normal operation mode and in the inspection and maintenance operation mode, i.e. already existing operation switches on the car operation panel (also referred to as “normal operation switches”, e.g. car call switches or buttons) are used to provide the necessary commands for manually driving the car upwards or downwards in the inspection and maintenance operation mode (e.g. for providing UP, DOWN, and RUN commands).

The operation switches on the car operation panel usually have the configuration of operation buttons, e.g. push buttons. However, any other type of operation mechanism is conceivable as well, e.g. touch pads, snap action switches, dip switches, toggle switches, and the like. The term “operation switch” is intended to refer to any of these types of operating mechanisms.

Particular embodiments may include any of the following optional features, alone or in combination:

After switching to the inspection and maintenance operation mode, at least one of the car operation switches of the car operation panel may be assigned to the function of commanding the car to manually travel in the up direction (also referred to as “UP command”), and another one of the car operation switches of the car operation panel may be assigned to the function of commanding the car to manually travel the car in the down direction (also referred to as “DOWN command”).

After switching to the inspection and maintenance operation mode, at least one of the car operation switches of the car operation panel may be assigned to the function of a car travel release switch releasing movement of the car in up/down direction (also referred to as “RUN command”). Movement of the car in up direction may be released in case the UP command switch and the car travel release switch are operated synchronously. Movement of the car in down direction may be released in case the DOWN command switch and the car travel release switch are operated synchronously.

To avoid inadvertent operation of the car operation switches used for manually controlling car operation in the inspection and maintenance mode, the UP command or DOWN command car operation switches, on the one hand, and the car travel release switch on the other hand may be arranged in such a way that operation of both switches synchronously cannot be achieved by using only one hand of a service person. Particularly, the UP command or DOWN command switches are located far enough away from the car travel release switch that synchronous operation of one of the switches assigned to commanding travel of the car in up direction or down direction and the car travel release switch requires two hands of a service person.

The car operation switches of the car operation panel may include at least one destination floor switch, each of the destination floor switches being assigned to a respective one of the destination landings or destination floors that can be serviced by the elevator car. Further, after switching to the inspection and maintenance operation mode, at least one of the destination floor switches of the car operation panel may be a DOWN command switch assigned to the function of commanding the car to manually travel the car in the down direction, at least one of the destination floor switches of the car operation panel may be an UP command switch assigned to the function of commanding the car to manually travel the car in the up direction, and at least one of the destination floor switches of the car operation panel may be assigned to the function of the car travel release switch releasing movement of the car in the up/down direction.

Usually, the car operation panel has further normal operation switches, e.g. switches for opening the car door, closing the car door, calling for help, and the like. The function of such car operation switches may remain unchanged when entering the inspection and maintenance operation mode.

The car operation panel may include at least one portion being mechanically detachable from the car operation panel such as to switch the car operation panel from a first configuration corresponding to the normal operation mode to a second configuration corresponding to the inspection and maintenance operation mode.

The at least one portion of the car operation panel should be at least temporarily detachable from the car operation panel. It is not required to fully separate the detachable portion from the car operation panel. Rather, it might be sufficient in particular embodiments if the position of the detachable portion with respect to other, non-detachable portions of the car operation panel changes (e.g. the detachable portion might be pivotable with respect to other non-detachable portions).

In particular embodiments, the car operation panel may have a cover and the mechanically detachable portion may form at least a part of the cover. The cover of the car operation panel may form at least one front face to which the car operating switches are mounted such as to be operable from the front side of the car operation panel in normal operation mode. Detaching a portion of the cover will expose a different front face in the region covered by the detached portion. At least part of the car operation switches located in that portion of the front face will be assigned to new functions in the inspection and maintenance operation mode. The position and/or configuration of at least those car operation switches to be used in the inspection and maintenance operation mode should normally remain unaffected by the mechanical change caused by detaching the detachable portion, such that these switches can be used in the inspection and maintenance mode operation for manually operating the car. The position and/or configuration of other car operation switches not used in inspection and maintenance mode might be changed such that these switches become disabled in the inspection and maintenance mode.

This includes the possibility of fully detaching the cover such that the front face will be changed completely in the configuration corresponding to the inspection and maintenance operation mode. Nevertheless, the same operation switches as used in the normal operation mode may be used in the inspection and maintenance operation mode as well. However, these switches will be assigned to different functions in the inspection and maintenance operation mode from those in the normal operation mode.

The mechanically detachable portion may form a portion of the cover having at least one opening or receptacle for accommodating at least one operation switch of the car operation panel, the at least one car operating switch being assigned to a different function after switching the car operation panel to the inspection and maintenance operation mode. Such different function may be any of commanding the elevator car to travel in up direction in manual operation mode (also referred to as UP command), commanding the elevator car to travel in down direction in manual operation mode (also referred to as DOWN command), and releasing travel of the elevator car in manual operation mode (also referred to as RUN command). Particularly, the detachable portion may include openings or receptacles for accommodating all of these switches.

In particular embodiments, the mechanically detachable portion may have the configuration of a flap that is pivotably supported to the car operation panel. Such configuration might allow the mechanically detachable portion to be pivoted away from the car operation panel. For example, the mechanically detachable portion may be supported by the car operation panel via a hinge and a lock. In the configuration corresponding to the normal operation mode, the mechanically detachable portion may be attached to, or accommodated by, a front panel of the car operation panel, such as to form a front face of the car operation panel. By releasing the lock, the mechanically detachable portion can be pivoted away from the front panel and form a flap being flapped out of the car operation panel, while still being fixed to the car operation panel via the hinge. Releasing the lock and/or the pivoting of the flap may be detected by a suitable sensor. The sensor signal may trigger the switching of the operation mode between the normal operation mode to the inspection and maintenance operation mode.

In further embodiments, the mechanically detachable portion may have the configuration of a flap that is removably attached to the car operation panel. In such configurations, the mechanically detachable portion can be taken off the car operation panel completely. The mechanically detachable portion may be supported by the car operation panel by a suitable fastening means, e.g. by a clip mechanism. In the configuration corresponding to the normal operation mode, the mechanically detachable portion may be attached to, or accommodated by, a front panel of the car operation panel, such as to form a front face of the car operation panel. By releasing the lock, the clip mechanism can be unlocked and the mechanically detachable portion can be taken away from the front panel. Releasing the lock may be detected by a suitable sensor such as to switch the operation mode from normal operation mode to inspection and maintenance operation mode.

In further embodiments, the mechanically detachable portion may be re-attachable to the car operation panel. Re-attachment of the detachable portion to the car operation panel may be detected by a suitable sensor such as to switch the operation mode from normal operation mode to inspection and maintenance operation mode.

Particularly, the mechanically detachable portion may be re-attachable to the car operation panel in the same position at the car operation panel, but in a different orientation, compared to the configuration of the car operation panel corresponding to the normal operation mode. Alternatively, the mechanically detachable portion may be re-attachable to the car operation panel in a different position at the car operation panel compared to configuration of the car operation panel corresponding to the normal operation mode.

Particularly, any of the car operating switch for commanding the car to travel in in up direction, the car operating switch for commanding the car to travel in in down direction, and the car travel release switch may be secured against inadvertent operation, at least when the car operation panel is switched to the inspection and maintenance operation mode.

For example, suitably re-attaching the mechanically detachable portion to the front side of the car operation panel may provide for a securing of the car operation panel against inadvertent operation. The mechanically detachable portion may have to be re-attached to the car operation panel in a backside-turned-to-front configuration. Collars may be provided around the receptacles or openings for accommodating the respective operation switches. These collars might be located on the back side of the detachable portion in normal operation mode. In the inspection and maintenance mode, the detachable portion will be re-attached with its back side now facing to the front side of the car operation panel, such that these collars will project from the front side of the car operation panel. In that configuration, car operation switches accommodated by the detachable portion will be recessed with respect to the collars, and thus be protected against inadvertent operation.

In particular embodiments, the car operation panel may comprise a sensor configured to detect that the mechanically detachable portion has been detached and/or configured to detect that the mechanically detachable portion has been reattached in the correct position and/or in the correct orientation.

Further embodiments relate to an elevator car, comprising a car operation panel configured to be operated by passengers inside the car in order to receive car calls, and to communicate the car calls to a control system of the elevator, the car operation panel having a configuration as set out herein.

Further embodiments relate to an elevator system, comprising at least one car configured to travel between different landings in a building in order to transport passengers between the landings, the elevator system including a car having a car operation panel as set out herein. Particularly, the elevator system may be a traction drive elevator system comprising a tension member connected to the elevator car and drivingly engaging a traction drive machine of the elevator system. The drive machine may include a drive motor coupled to a drive sheave. The elevator car particularly is driven by a tension member having the configuration of a belt. The elevator system particularly includes a counterweight, the tension member connecting the elevator car and the counterweight such as to drive the car and counterweight in opposite directions.

While the invention has been described by taking reference to specific exemplary embodiments, it is to be readily understood that the invention is not limited to these embodiments and is only defined by the scope of the appended claims.

### LIST OF REFERENCE SIGNS

10: Elevator car
12: Left interior side wall
14: Right interior side wall
16: Back interior side wall
18: Floor or landing
20: Ceiling
22: Vertical column supporting car operation panel
24A-24D: Vertical illumination profiles in corners of car
26A, 26B: Vertical illumination profiles at the sides of column 22
28: Display
30: Car operation panel
32: Normal car operation switches assigned to destination landings
34: Other normal car operation switches
36: Detachable portion of front cover of car operation panel
38: Front cover of car operation panel
42: Opening or receptacle in front cover for accommodating normal car operation switch
42A: Enlarged opening provided in detachable portion of front cover
44: Non-detachable portion of front cover
46: Flap
48: Hinge
50: Lock
52: Keyhole
54: Auxiliary front cover
56: car operation switch/UP command switch
58: car operation switch/DOWN command switch
60: car operation switch/car travel release switch
62: Collar

1. A car operation panel (30) for commanding travel of an elevator car (10) from a boarding landing to a destination landing during normal operation of an elevator system, the car operation panel (30) having a plurality of car operation switches (32, 34, 56, 58, 60) to be operated by a passenger from inside the elevator car (10) during normal operation of the elevator system; the car operation panel (30) being mechanically convertible such as to switching the car operation panel (30) from a first configuration corresponding to the normal operation mode to a second configuration corresponding to an inspection and maintenance operation mode; wherein the car operation panel (30), when switched to the second configuration, allows manual control of the elevator car (10) to travel in an up direction and/or in a down direction by operating at least a part of the car operation switches (56, 58, 60) of the car operation panel (30).

2. The car operation panel (30) according to claim 1, wherein after switching to the inspection and maintenance operation mode, at least one of the car operation switches (56) of the car operation panel (30) is assigned to the function of an UP command switch commanding the car to manually travel in the up direction, and another one of the car operation switches (58) of the car operation panel is assigned to the function of a DOWN command switch commanding the car to manually travel the car in the down direction.

3. The car operation panel (30) according to claim 2, wherein after switching to the inspection and maintenance operation mode, at least one of the car operation switches (60) of the car operation panel (30) is assigned to the function of a car travel release switch releasing movement of the elevator car (10) in up/down direction; wherein movement of the elevator car (10) in up direction is released in case the UP command switch (56) and the car travel release switch (60) are operated synchronously, and wherein movement of the elevator car (10) in down direction is released in case the DOWN command switch (58) and the car travel release switch (60) are operated synchronously.

4. The car operation panel (30) according to claim 3, wherein the UP or DOWN command switches (56, 58), on the one hand, and the car travel release switch (60), on the other hand, are arranged in such a way that operation of both switches (56, 60; 58, 60) synchronously cannot be achieved by using only one hand of a service person.

5. The car operation panel (30) according to claim 1, wherein the car operation switches (32, 34, 56, 58, 60) of the car operation panel include at least three destination floor switches (56, 58, 60), each of the destination floor switches (32) being assigned to a respective one of the destination floors that can be serviced by the elevator car (10); wherein further, after switching to the inspection and maintenance operation mode, at least one of the destination floor switches (56) of the car operation panel is assigned to the function of an UP command switch commanding the elevator car (10) to manually travel in up direction, at least one of the destination floor switches (58) of the car operation panel (30) is assigned to the function of a DOWN command switch commanding the elevator car (10) to manually travel in down direction, and at least one of the destination floor switches (60) of the car operation panel (30) is assigned to the function of a car travel release switch releasing movement of the elevator car (10) in the up/down direction.

6. The car operation panel (30) according to claim 1, wherein the car operation panel (30) includes at least one portion (36) which is mechanically detachable from the car operation panel (30) such as to switch the car operation panel (30) from the first configuration corresponding to the normal operation mode to the second configuration corresponding to the inspection and maintenance operation mode.

7. The car operation panel (30) according to claim 6, wherein the car operation panel (30) has a cover (38) and the mechanically detachable portion (36) forms at least a part of the cover.

8. The car operation panel (30) according to claim 7, wherein the mechanically detachable portion (36) forms a portion of the cover (38) having at least one opening or receptacle (42) for accommodating at least one car operation switch (56, 58, 60) of the car operation panel (30), the at least one car operating switch (56, 58, 60) being assigned to a different function after switching the car operation panel (30) to the inspection and maintenance operation mode.

9. The car operation panel (30) according to claim 7, wherein the mechanically detachable portion (36) has the configuration of a flap (46) pivotably attached to the car operation panel (30).

10. The car operation panel (30) according to claim 7, wherein the mechanically detachable portion (36) has the configuration of a flap removably attached to the car operation panel (30).

11. The car operation panel (30) according to claim 7, wherein the mechanically detachable portion (36) is re-attachable to the car operation panel (30).

12. The car operation panel (30) according to claim 11, wherein the mechanically detachable portion (36) is re-attachable to the car operation panel (30) in the same position at the car operation panel (30), but in a different orientation (36R), compared to the normal operation mode.

13. The car operation panel (30) according to claim 7, wherein any of the UP command switch (56), the DOWN command switch (58), and the car travel release switch (60) are secured against inadvertent operation, at least when the car operation panel (30) is switched to the second configuration corresponding to the inspection and maintenance operation mode.

14. The car operation panel (30) according to claim 7, further comprising a sensor configured to detect that the mechanically detachable portion (36) has been detached from the car operation panel (30) and/or configured to detect that the mechanically detachable portion (36) has been reattached in the correct position and/or in the correct orientation to the car operation panel (30).

15. Elevator car (10), comprising a car operation panel (30) configured to be operated by passengers inside the elevator car (10) in order to receive car calls, and to communicate the car calls to an elevator control system, the car operation panel (30) having a configuration as set out in claim 1.

16. Elevator system, comprising at least one elevator car (10) configured to travel between different landings in a building in order to transport passengers between the landings, the elevator system including an elevator car (10) having a car operation panel (30) as set out in claim 1.
